(19) United States
(12) Patent Application Publication
(10) Pub. No.: US 2012/0260497 A1
(43) Pub. Date: Oct. 18, 2012

(54) SURGICAL INSTRUMENT

(75) Inventors: Michael White, Leeds (GB); Chris Harrison, Leeds (GB)

(73) Assignee: Surgical Innovations Limited, Leeds (GB)

(21) Appl. No.: 13/500,332

(22) PCT Filed: Oct. 7, 2010
(86) PCT No.: PCT/GB2010/051679

§ 371 Date: Jun. 22, 2012

(30) Foreign Application Priority Data
Oct. 8, 2009 (GB) 0917560.5

(51) Int. Cl. B23P 21/00

(52) U.S. Cl. 29/705

(57) ABSTRACT

A rod (7) is initially straight. However, the segments (3,32,34,36,38,40 and 42) are able to be moved such that there is a cross over at two locations. Segments (14) can start off with an initial straight shape and can be brought into a curved configuration. The segments are hollow and a camera (54) can be manipulated to extend out through opposed elongate openings (48) in each segment.

The present invention relates to an instrument incorporating a tool, a method of effecting an operation including a tool, an instrument including an elongate portion and a method of operating an instrument including an elongate portion.

The present invention is particularly, although not exclusively relevant to instruments and methods for examining ceramic tiles on turbines.

A problem with inspecting ceramic tiles on turbines is that the turbine is out of commission for a long time. That is partly because of the period that it takes for the turbine to cool down and partly because of the time taken to inspect the many tiles without contacting the tiles.

It is an object of the present invention to attempt to overcome at least one of the above or other disadvantages.

GB 2 475 746 discloses a method for inspecting the blades of a turbine engine.

According to one aspect of the present invention an instrument includes an elongate portion movable from a first configuration to a second, different configuration, the instrument including a channel extending at least partially along the elongate extent of the instrument and a tool located at least partially in the channel, the tool being arranged to effect an operation at at least one side of the instrument.

According to another aspect of the present invention a method of effecting an operation comprises altering the configuration of an elongate portion from a first configuration to a second configuration and effecting an operation at at least one side of the elongate portion with a tool located at least partly in a channel of the elongate portion.

According to a further aspect of the present invention an instrument includes an elongate portion movable from a first configuration to a second, different configuration, the instrument including an operative member attached to the elongate portion at a first location and including an extent external to the elongate portion, the operative member, in use, being arranged to exert a force on the elongate portion to at least partially assist in causing the elongate portion to move at least part of the way between the first and second configurations.

The operative member may be spaced from the elongate portion during at least part of the movement from the first to the second configuration.

The operative member may be constrained to extend between two locations of the elongate member which locations are spaced from each other along the elongate extent of the elongate member and the operative member may be arranged to be fixed at a first location and is arranged to slide at a second location. The first location may comprise an end region of the elongate portion. The length of the operative member between the two locations may be arranged to shorten during at least part of the movement from the first to the second configuration and may be arranged to bring one portion of the elongate portion into contact with another portion of the elongate portion at spaced locations along the elongate extent of the elongate portion. The effective length of the elongate portion between the two locations may be arranged to first shorten and then lengthen as the elongate portion moves from the first configuration towards the second configuration.

The operative member may be arranged to exert a force on the elongate portion to move the elongate portion away from a straight configuration.

The operative portion may be arranged to be slack in the second configuration.

The operative member may be arranged to be slack before movement from the first configuration to the second configuration commences.

The operative member may comprise a flexible member.

The elongate portion may include control means which extend internally along the elongate member arranged to at least partially assist in moving the elongate portion at least part of the way between the first and second configurations and the elongate member may include a plurality of segments adjacent to each other each of which are able to have their relative extent in the elongate direction altered. Control means may be arranged to coordinate the actuation of the control means that assist in moving the elongate portion from the first to the second configuration and arranged to control the operation of the operative member. The control means may constrain the elongate member to be within a predefined space when the elongate portion moves from the first to the second configuration. The operative member may reduce the space that the elongate portion occupies as the elongate portion moves from the first to the second configuration from that which the elongate portion would have moved through if only the control means were to effect the movement from the first to the second configuration.

According to a still further aspect of the present invention a method of operating an instrument includes an elongate portion and an operative member attached to the elongate portion, the operative member including an extent external to the elongate portion the method comprising exerting a force on the elongate portion thereby causing the elongate portion to move from the first configuration to a second, different configuration.

According to another aspect of the present invention an instrument includes an elongate portion movable from a first configuration to a second, different configuration, the elongate portion comprising a plurality of segments that are connected to each other by a connection means and that are movable relative to each other whereby the elongate portion can move from the first to the second configuration, the connection means comprising at least one pivot member acting as a hinge between the segments.

The rotational axis of the hinge may be spaced away from the longitudinal axis of the elongate portion at a side region of the instrument and may be perpendicular to the longitudinal axis of the elongate portion.

The pivot member may extend from a first segment, through a second adjacent segment and then to the first segment again and a flange of the second member may be located in a recess of the first member with the hinge cooperating with the flange and recess. One end of a segment may include a recess and the other end a flange. The combined extent of the flange and the parts that define the recess may be greater than 20% of the maximum width of the segments. A cut away portion may extend in the direction of the rotational axis of the hinge from each side of the hinge on each segment towards the outer periphery of the instrument and the cut out portions may be arcuate, when viewed from the side with the arc opening to the outside of the segments. The extent of the pivot member may be less than half the extent across a segment and may be one third of the extent across a segment.

Adjacent segments may include planar surfaces that are arranged to abut each other at a limit position to prevent further movement about the hinge.

Actuation means may extend through adjacent segments at a distance from the hinge arranged to urge adjacent segments to move from the first to the second configuration and the actuation means may comprise two flexible members extending along opposed side regions of the segments. The members may extend through different passages in the segments. The actuation means may be located in the middle of the segments, away from the hinge. When the actuation means are not actuated each segment may be arranged to be able to suspend an adjacent segment by the pivot member.

The segments, in cross section, may be thicker in the region of the pivot member than at least one other region of the segments and the thickness of a cross section of a segment may decrease as the distance away from the pivot member increases.

According to a further aspect of the present invention a method of connecting a plurality of segments of an elongate instrument such that the segments can move from a first configuration to a second, different configuration comprises using a pivot member to act as a hinge between the segments.

Any of the aspects of these inventions may be combined.

The present invention can be carried into practice in various ways but one embodiment will now be described by way of example and with reference to the accompanying drawings, in which:

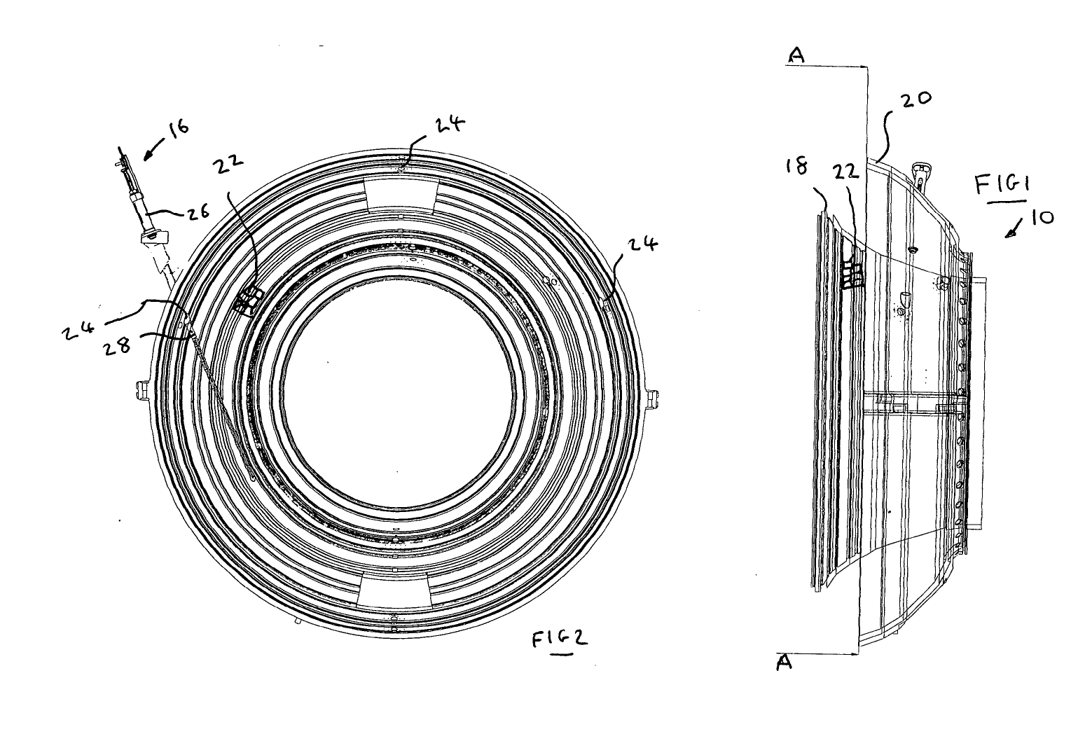

FIG. 1 is a side view of a turbine 10 that is to be inspected;

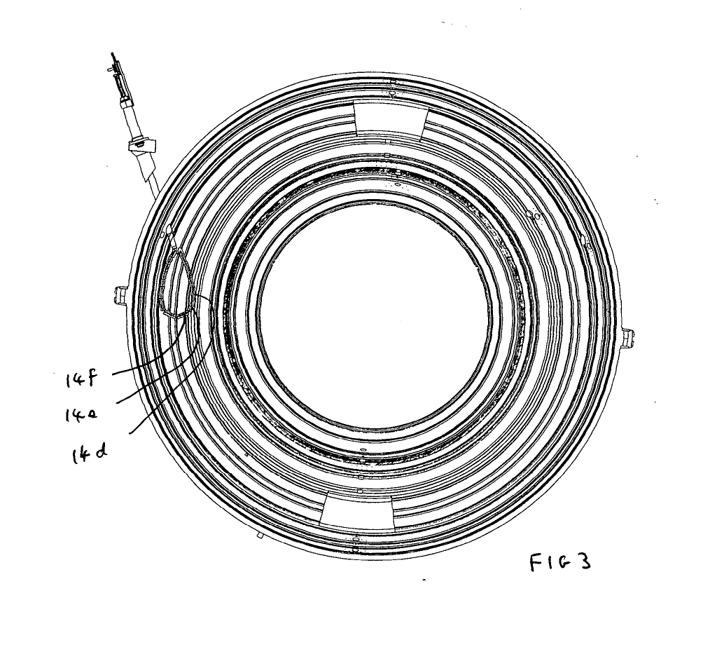

FIGS. 2 to 6 are sectional views along the line A-A of FIG. 1 from the initial insertion configuration of an instrument to a configuration in which the instrument finally ends up in for the inspection;

FIG. 7 is a perspective of the instrument;

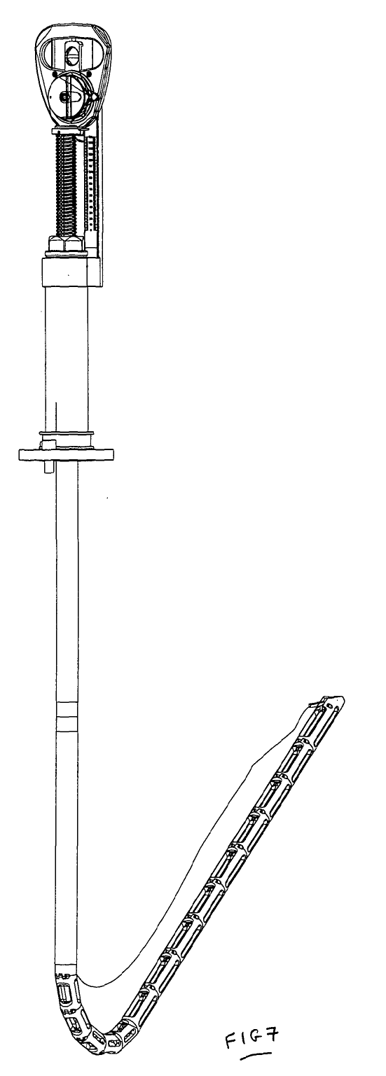

FIG. 8 is a side view of a pair of segments 14 of the instrument;

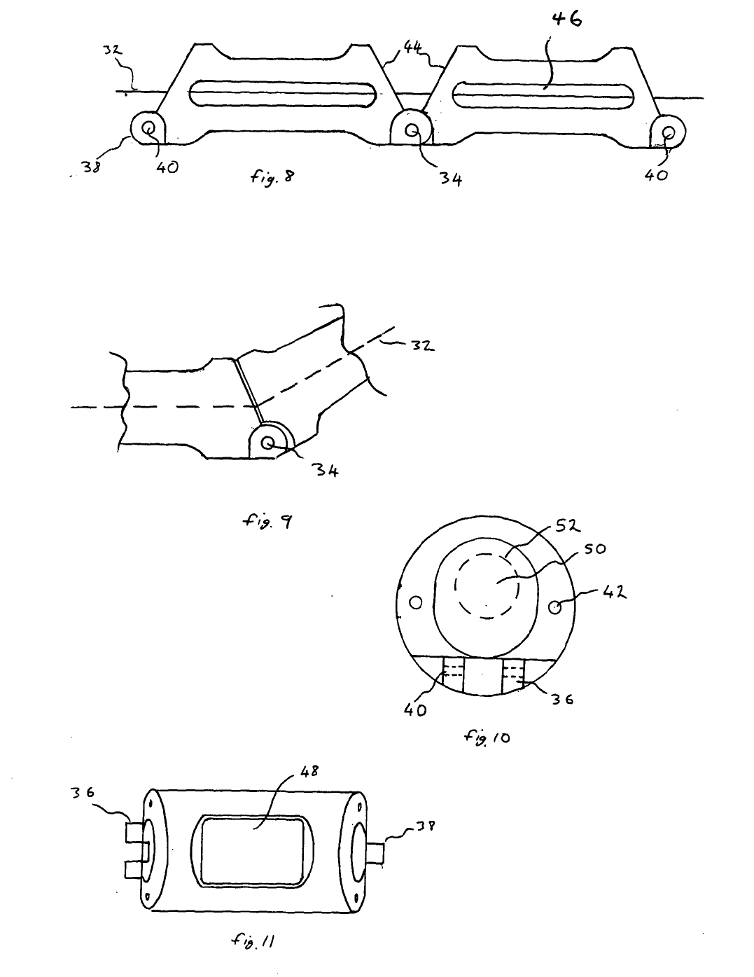

FIG. 9 is a side view of the pair of segments 14 in a configuration for inspection;

FIG. 10 is an end view of a segment 14;

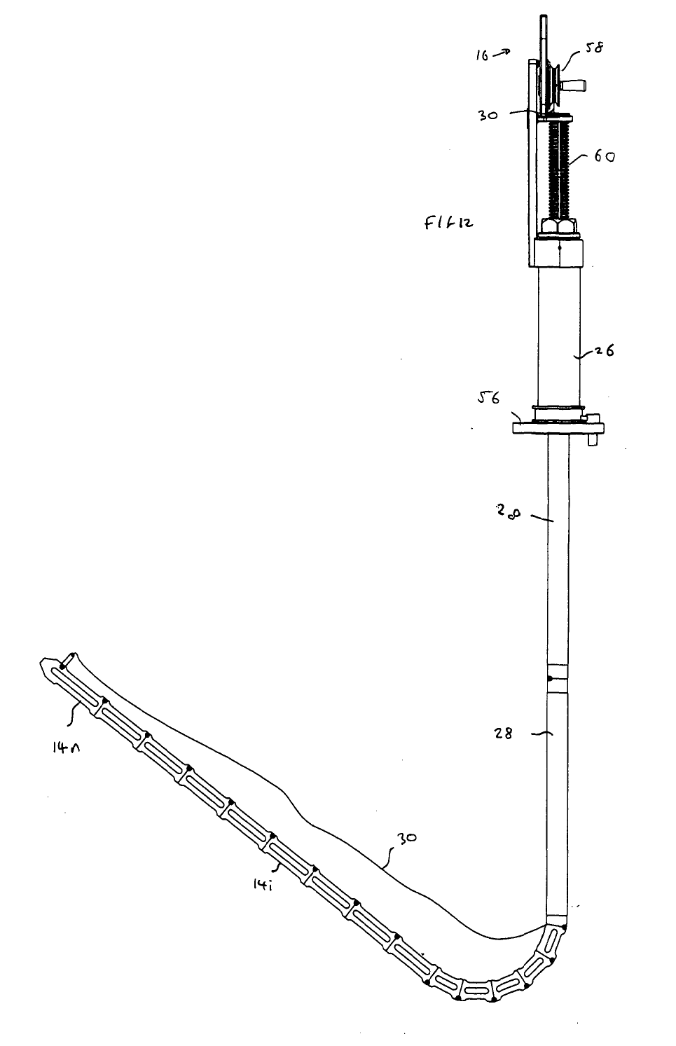

FIG. 11 is a plan view of a segment 14;

FIG. 12 is a side view of the segments in the final, inspection position;

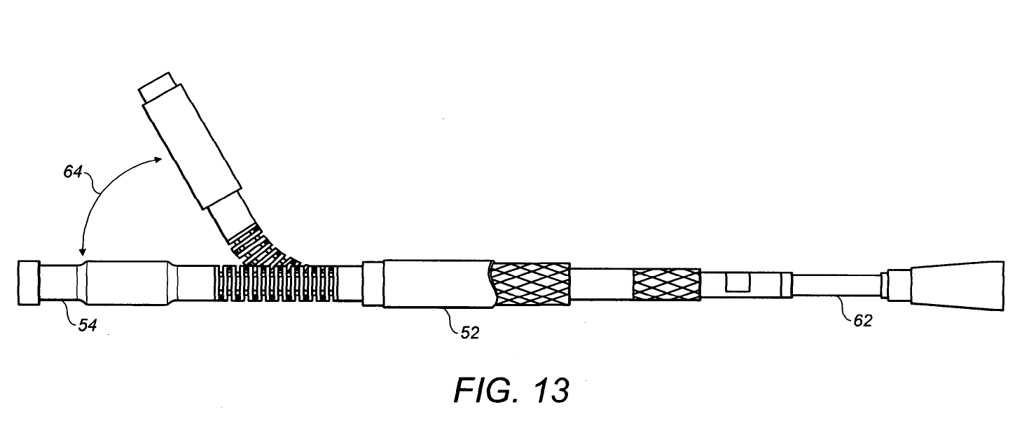

FIG. 13 is a side view of the camera.

As shown in FIGS. 1 and 2, the turbine 10 includes an inner core 18 in the form of a trumpet and an outer fairing 20. The surfaces of the core and fairing that face each other include ceramic tiles 22 that are subject to extreme heat.

The fairing 20 is provided with a series of entry ports 24.

In use, the instrument 12 is inserted through one of the ports 24 in a straight configuration, as shown in FIG. 2 with the instrument being threaded through a short tube 26 of the control 16.

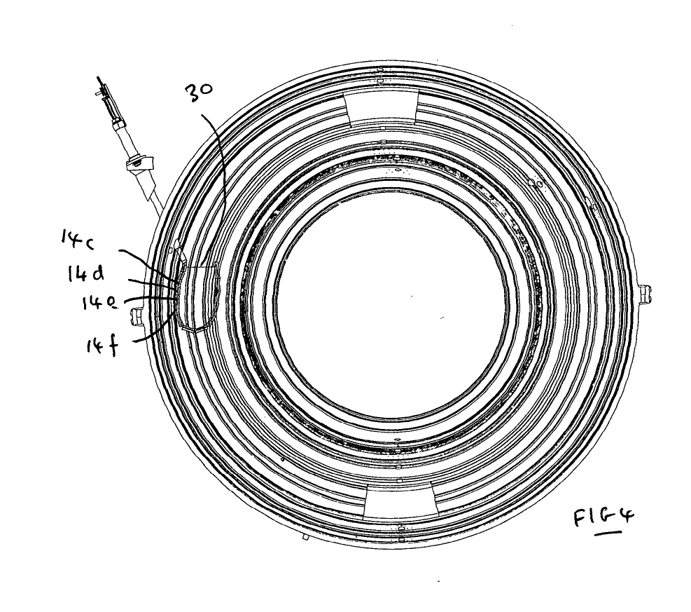

The upper, proximal end of the instrument includes a tube 28 that slides through the control tube 26 and projects a short distance from the control tube. A line 30 extends along the outside of the instrument from the bottom of the tube 28 to the distal, end segment 14n as shown in detail in FIG. 12. This line 30 assists in the instrument taking up its shape. The line 30 is then tensioned to bring the instrument into the shape shown in FIG. 3. It will be appreciated that the turbines can have a diameter of 4 m and consequently the instruments can have a considerable weight. The line 30 places the instrument in a position at which a control wire 32, to be described later, can turn adjacent segments relative to each other with a good mechanical advantage.

In the position shown in FIG. 3 adjacent segments 14d, 14e and 14f are brought into their final relative positions by the tension of the line 30.

The control wire 32 that connects each segments it then tightened and, at the same time or before or after or with an overlap of control of the line 30 and the wire 32, the line 30 is released slightly so that the instrument reaches the position shown in FIG. 4. In this position the segments 14c and 14d are in their final relative position.

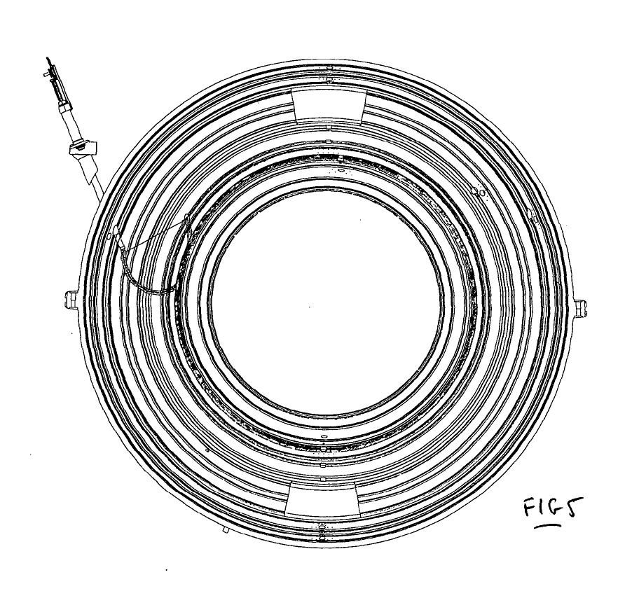

From the position shown in FIG. 4 the line 30 is released further and the wire 32 is further tightened in the way described above in relation to the movement from FIGS. 3 to 4 to reach the position shown in FIG. 5. In this configuration the adjacent segments 14a to 14i are all in their final relative configuration.

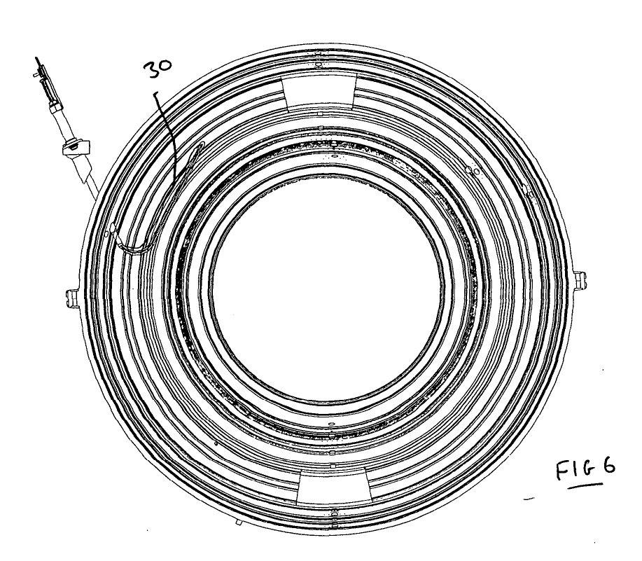

Further tensioning of the control wire 32 and the slackening of the line 30 in the way described in relation to the movement from FIGS. 3 to 4 leaves the instrument in the final configuration shown in FIGS. 6 and 12. In this position the line 30 is slack and each adjacent segment abuts each other and are unable to turn further. In addition the segment 14a has turned relative to the instrument tube 28 such that further relative turning is prevented.

The line 30 and the control wire 32 may be coordinated to ensure that the instrument does not touch the tiles such that, for instance, without the use of the line 30 the instrument would inevitably touch the tiles.

Thus a rigid instrument is provided. The operation of the instrument will be described later.

The segments will now be described in greater detail. It will be appreciated that not all segments need be the same length. Indeed it can be seen in FIGS. 2 to 6 that the segments 14a to 14e are half the length of the remaining segments.

As shown in FIGS. 8 to 10 adjacent segments are connected together by a pin 34. One end of each segment includes a pair of spaced projecting flanges 36 and the other a central flange 38. The central flange 38 is located between spaced flanges 36 of an adjacent segment and the pin 34 extends through aligned openings 40 in the flanges 36,38. The combined extent of the flanges 36 and the flange 38 is ⅓ of the maximum width of the segment. However, that combined extent may be more than 10 or more than 20 or more than 30 or more than 40% or less than 90 or less than 80 or less than 70% of the maximum width.

Elongate spaced holes 42 extend down each side of the segments. The control wire 32 extends down one of the inclined holes 42 in adjacent segments, around the end segment and then back through the other holes. The holes 42 are spaced from the pins 34. Consequently tension of the control wire 32 causes relative rotation of adjacent segments about the pins 34 until adjacent planar faces 44 abut each other, as shown in FIG. 9.

For weight reduction each side of each segment includes an elongate opening 46. Furthermore, as shown in FIG. 10, whilst the exterior cross-section is circular the interior cross-section is thicker at the lower portion where the hinges are located and where the maximum forces will be experienced than at the top portion with the thickness decreasing from a lower region, then to the side middle regions to the thinnest top region.

As shown in FIG. 11, each segment includes an elongate opening 48 at the top and bottom.

It can be seen from FIG. 10 in particular that the segments provide a clear operating corridor 50 along the complete length of the instrument. A flexible cord 52 having a camera 54 at the distal tip can be located in the corridor. The tip of the cord 52 having the camera can be bent by a camera operator at the control 16 to extend out through the opposed elongate openings 48 in each segment. In this way the tiles 22 on both the inner core 18 and fairing 20 are able to be viewed for damage such as cracks, for instance. Damaged tiles can be replaced. Viewing may be manual or may be automated.

It will be appreciated that the present invention is not restricted to the inspection of damaged tiles and the interior of any machine could be inspected by an inspection member, which may not necessarily be a camera, inspecting through the side of a carrier.

The camera 52 may be located at the distal region of the segments when the instrument is inserted into the turbine and pulled back under tension. Alternatively the camera 54 may be inserted into the segments after they have taken up the inspection configuration shown in FIGS. 6 and 12 in which case the inspection can take place as the camera advances or, alternatively, the camera can be inserted to the end of the instrument and then pulled back to make the sequence of inspections.

The cord can then be indexed, either by retraction from the corridor or by advancement through the corridor with the camera being alternately extended through each opening 48 of each segment.

It will be appreciated that the camera may be advanced at different distances from different openings. Furthermore, the camera, once through an opening 48, can view at least partially rearwardly, at least partially forwardly or at least partially to at least one side or any combination thereof, possibly by further manipulation of the camera once through the opening.

The control 16 comprises a housing 56 shown in FIG. 12 that is clamped to one of the entry ports 24. At the same time, or subsequently, a housing may be clamped to the other entry ports 24. In this way the complete periphery of the tiles is visible.

The control tube 24 that is fast with the housing extends both into the turbine and upwardly beyond the housing at an angle to the perpendicular of the surface that the housing is attached to.

As shown in FIG. 12 the line 30 is controlled by a winding reel 58. The control wires are tensioned or slackened by a hollow threaded member 60. The cord 52 of the camera is fed through the hollow threaded member 60.

The manipulation of the camera tip is well known and is effected by pulling articulation cables 62 shown in FIG. 13 to cause the tip to move from a straight position to a curved position as indicated by the arrow 64. Fibre optic cables within the cord 52 carry the images of the camera to a control.

The control may include actuators that control the operation of the line 30, the control wire 32 and the location of the cord 52 and operating the camera 54. The control may automatically sequence the operation of any one or more of the actuators.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An instrument including an elongate portion movable from a first configuration to a second, different configuration, the instrument including a channel extending at least partially along the elongate extent of the instrument and a tool located at least partially in the channel, the tool being arranged to effect an operation at at least one side of the instrument.

2. An instrument as claimed in claim 1 in which the operation is arranged to be effected at more than one side.

3. An instrument as claimed in claim 1 or 2 in which the operation is arranged to be effected at a location spaced from the distal end.

4. An instrument as claimed in any preceding claim in which the operation is arranged to be effected at a plurality of locations along the instrument.

5. An instrument as claimed in claim 4 in which the tool is arranged to be moved along the channel to effect an operation at a plurality of locations.

6. An instrument as claimed in claim 5 in which the tool is arranged to be advanced to effect an operation at a plurality of locations.

7. An instrument as claimed in claim 5 the tool is arranged to be retracted to effect an operation at a plurality of locations.

8. An instrument as claimed in any of claims 6 to 8 including a control arranged to move the tool along the channel and to effect the operation.

9. An instrument as claimed in any preceding claim in which the window comprises an opening.

10. An instrument as claimed in claim 9 in which the tool is arranged to extend at least partially through the opening in the instrument to effect the operation.

11. An instrument as claimed in claim 10 in which the extent of the tool through the opening is variable.

12. An instrument as claimed in claim 10 or 11 in which the tool is arranged to project beyond the opening.

13. An instrument as claimed in any of claims 10 to 12 in which the orientation of the distal region of the tool is adjustable when extending at least partially through the opening.

14. An instrument as claimed in any preceding claim in which at least the second configuration of the tool is predetermined.

15. An instrument as claimed in claim 14 in which the elongate extent of the elongate portion is moved to the second configuration upon activation of a control member.

16. An instrument as claimed in any preceding claim in which the instrument comprises a turbine inspection instrument.

17. An instrument as claimed in any preceding claim in which the tool comprises a camera.

18. A method of effecting an operation comprising altering the configuration of an elongate portion from a first configuration to a second configuration and effecting an operation at at least one side of the elongate portion with a tool located at least partly in a channel of the elongate portion.

19. A method as claimed in claim 18 in which the tool is moved along the channel to effect the operation at different elongate extents.

20. A method as claimed in claim 18 or 19 in which the tool is moved to extend at least partially through an opening in the elongate portion to effect the operation.

21. A method of effecting an operation as claimed in one of claims 18 to 20 when using an instrument as claimed in any of claims 1 to 17.

22. An instrument as claimed in any of claims 30 to 39 in which the operative member is arranged to be slack before movement from the first configuration to the second configuration commences.

23. An instrument as claimed in any of claims 30 to 40 in which the operative member comprises a flexible member.

24. An instrument as claimed in any of claims 30 to 41 in which the elongate portion includes control means which extend internally along the elongate member arranged to at least partially assist in moving the elongate portion at least part of the way between the first and second configurations.

25. An instrument as claimed in claim 42 in which the elongate member includes a plurality of segments adjacent to each other each of which are able to have their relative extent in the elongate direction altered.

26. An instrument as claimed in claim 42 or 43 including control means arranged to coordinate the actuation of the control means that assist in moving the elongate portion from the first to the second configuration and arranged to control the operation of the operative member.

27. An instrument as claimed in claim 44 in which the control means constrains the elongate member to be within a predefined space when the elongate portion moves from the first to the second configuration.

28. An instrument as claimed in claim 45 in which the operative member reduces the space that the elongate portion occupies as the elongate portion moves from the first to the second configuration from that which the elongate portion would have moved through if only the control means were to effect the movement from the first to the second configuration.

29. A method of operating an instrument including an elongate portion and an operative member attached to the elongate portion, the operative member including an extent external to the elongate portion the method comprising exerting a force on the elongate portion thereby causing the elongate portion to move from the first configuration to a second, different configuration.

30. A method as claimed in claim 47 when operating an instrument as claimed in any of claims 30 to 46.
